(19) United States
(12) Patent Application Publication
(10) Pub. No.: US 2026/0101074 A1
(43) Pub. Date: Apr. 9, 2026

(54) Obtaining Search Results and Recommendations Using Language Models

(71) Applicant: Spotify AB, Stockholm (SE)

(72) Inventors: Gustavo Penha, Delft (NL); Ali Vardasbi, Amsterdam (NL); Enrico Palumbo, Turin (IT); Marco De Nadai, Copenhagen (DK); Hugues Bouchard, Barcelona (ES)

(21) Appl. No.: 19/352,890

(22) Filed: Oct. 8, 2025

Related U.S. Application Data
(60) Provisional application No. 63/705,397, filed on Oct. 9, 2024.

(51) Int. Cl. H04N 21/25; H04N 21/258; H04N 21/472

(52) U.S. Cl. CPC H04N 21/252; H04N 21/25866; H04N 21/47202

(57) ABSTRACT

Example implementations include methods and systems that relate to search results and recommendations in a media content delivery system. An example method includes providing a search query to a multi-task language model associated with a media content delivery system. The method also includes providing user engagement information to the multi-task language model. The user engagement information indicates user engagement activity with the media content delivery system. The method also includes retrieving, using the multi-task language model and based on the search query, one or more candidate media items from a media item database of the media content delivery system. The method also includes identifying, using the multi-task language model and based on the user engagement information, one or more recommended media items from the media item database.

### CROSS-REFERENCE TO RELATED APPLICATION

The present application claims priority to U.S. Provisional Patent Application No. 63/705,397, filed Oct. 9, 2024, the contents of which are expressly incorporated herein.

### FIELD OF THE INVENTION

The present disclosure relates to the field of media content delivery systems. Specifically, the present disclosure pertains to methods, systems, and devices for retrieving content based on user search queries and recommending content based on user engagement activity.

### BACKGROUND

The growth in digital content available across various platforms has made it increasingly challenging for users to discover relevant media that aligns with their interests and preferences. This content may span a variety of formats, including video, audio, text, and interactive media, distributed across diverse media content delivery systems such as streaming services, social media platforms, and digital libraries. The sheer volume of content, coupled with the diversity of user preferences, necessitates advanced tools and methodologies to assist users in navigating and selecting from the vast array of available digital media.

Conventional media content search and recommendation systems can utilize trained machine learning (ML) models. In such scenarios, the ML models can be trained on existing data so the search results and recommendations provided to the user are relevant. In some examples, media content platforms may employ different task-specific models for different information retrieval tasks. As a non-limiting example, a media content platform may employ (i) a search-based model to search for media content based on a user query and (ii) a recommendation-based model to recommend media content based on user interactions with specific media content. However, when using the recommendation-based model to recommend media content to the user, latent representations of media items learned by the recommendation-based model may be biased towards popularity. In some instances, the user experience for a particular user of the streaming media platform may be diminished if recommended media items are heavily biased towards what is trending (e.g., popular), in particular if the particular user is not interested in trending media. Accordingly, it is desirable to provide recommendations to more relevant media items with less popularity bias.

### SUMMARY

Various implementations disclosed herein provide improved digital content recommendations and search results by using a language model (LM). The described methods and systems orchestrate and generate search results and recommendations based on users' entertainment needs. These methods and systems advance the user content search and recommendation process from a conventional media content delivery system to an agent that utilizes both search queries and user engagement activity to provide more relevant media content recommendations and search results.

In particular, the present disclosure describes a multi-task language model (e.g., a large language model) that is operable to (i) identify media items, from a catalog of media items, based on a user search and (ii) recommended media items, from the catalog of media items, based on historical user interactions. To illustrate, a first dataset may be used to train a search model (e.g., a bi-encoder model) and a second dataset may be used to train a recommendation model (e.g., a two-tower model). The search model may output first embeddings for each item in the first dataset, and the recommendation model may output second embeddings for each item in the second dataset. The first embeddings and the second embeddings may be fused together (e.g., combined) into a fused embedding space. An autoencoder may discretize the embeddings in the fused embeddings space into discrete identifiers that are added to the multi-task language model.

After the discrete identifiers are added to the multi-task language model, the multi-task language model may be trained based on subsets of the first dataset and the second dataset. To illustrate, with reference to the first dataset associated with the search context, training inputs for the multi-task language model may include tokens for textual queries and outputs may include tokens for relevant media items. With reference to the second dataset associated with the recommendation context, training inputs for the multi-task language model may include tokens for historical media items (e.g., previously accessed media items) and outputs may include tokens for relevant items. After completion of the training, the multi-task language model may be operable to retrieve media items for a query and retrieve them based on historical user interactions. Thus, by training a language model based on content-based information (e.g., tokens for textual queries) and collaborative-filtering-based information (e.g., tokens for historical media items), recommendations generated by the language model may be less biased toward popularity.

The disclosed methods and systems provide a number of technical advantages. For instance, by selecting subsets of the first dataset and the second dataset to train the multi-task language model, as opposed to using the entire first and second datasets, a reduced amount of training data may be used to train the multi-task language model. By reducing the amount of training data, the multi-task language model may be trained more efficiently so as to not waste computing resources.

Accordingly, a first example embodiment may involve a method. The method includes providing a search query to a multi-task language model associated with a media content delivery system. The method also includes providing user engagement information to the multi-task language model. The user engagement information indicates user engagement activity with the media content delivery system. The method also includes retrieving, using the multi-task language model and based on the search query, one or more candidate media items from a media item database of the media content delivery system. The method also includes identifying, using the multi-task language model and based on the user engagement information, one or more recommended media items from the media item database.

A second example embodiment may involve a device. The device includes a memory and a processor coupled to the memory. The processor is configured to provide a search query to a multi-task language model associated with a media content delivery system. The processor is also configured to provide user engagement information to the multi-task language model. The user engagement information indicates user engagement activity with the media content delivery system. The processor is also configured to retrieve, using the multi-task language model and based on the search query, one or more candidate media items from a media item database of the media content delivery system. The processor is also configured to identify, using the multi-task language model and based on the user engagement information, one or more recommended media items from the media item database.

A third example embodiment may involve a non-transitory computer-readable medium. The non-transitory computer-readable medium includes instructions that, when executed by a processor, cause the processor to perform operations. The operations include providing a search query to a multi-task language model associated with a media content delivery system. The operations also include providing user engagement information to the multi-task language model. The user engagement information indicates user engagement activity with the media content delivery system. The operations also include retrieving, using the multi-task language model and based on the search query, one or more candidate media items from a media item database of the media content delivery system. The operations also include identifying, using the multi-task language model and based on the user engagement information, one or more recommended media items from the media item database.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a block diagram illustrating a media content delivery system, in accordance with example embodiments.

FIG. 2 is a block diagram illustrating an electronic device, in accordance with example embodiments.

FIG. 3 is a block diagram illustrating a media content server, in accordance with example embodiments.

FIG. 4 is a block diagram illustrating a system that provides improved digital content recommendations and search results by using a multi-task language model, in accordance with example embodiments.

FIG. 5 is a block diagram illustrating a system for training a multi-task language model, in accordance with example embodiments.

FIG. 6 is a diagram of a first page of a graphical user interface, in accordance with example embodiments.

FIG. 7 is a diagram of a second page of the graphical user interface, in accordance with example embodiments.

FIG. 8 is a flow chart illustrating a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Overview of the Multi-Task Language Model

As described herein, for generative retrieval, a function φ may map each media item in a collection of media items to a respective identifier, which may include one or more tokens. A vocabulary of a LM (e.g., a pre-trained LM) may be comprised of vocabulary tokens that represent the textual natural language of the tokens used to represent the media items in the collection of media items. In some embodiments, atomic identifiers (IDs) for the function φ may be used. As a result, there may be one additional token per media item in the vocabulary. In other embodiments, semantic IDs based on content or collaborative embeddings may be used to scale to a larger set of media items. Generative models may be trained auto-regressively with teacher forcing, employing cross-entropy loss between the predicted ID tokens and the ground truth ID tokens. To perform retrieval with generative retrieval, beam search may be performed, returning the top valid item IDs.

As used herein, Dₛ={(Qi, {item₁, item₂, . . . , itemₖ})}^{N} may be a search dataset comprised of relevance labels for queries, where Q is the query and {item₁, item₂, . . . , itemₖ} are the media items that are relevant for the query. To train a generative model using the above-described search dataset, each query turns into input-output pairs having the format [(Q, φ(item₁)), . . . , (Q, φ(item₁))]. As used herein, a generative model trained on the search dataset (Dₛ) may be referred to as Gen_{S}.

As used herein, D_{R}={(Ui, {item₁, item₂, . . . , itemₜ₋₁}, item)}^{M} may be a recommendation dataset comprised of user interactions split into history and target pairs. The history pairs may correspond to previous interactions of the user sorted by time, and the target media item may be the last interacted media item. To train a generative model on the above-described data set, each user may turn into one pair of the format (concat(φ(item₁), φ(item₂), . . . φ(itemₜ₋₁)]), φ(itemₜ), where concat (·) is the concentration of the media item IDs with a space token. As used herein, a generative model trained on the recommendation dataset (D_{R}) may be referred to as Gen_{R}.

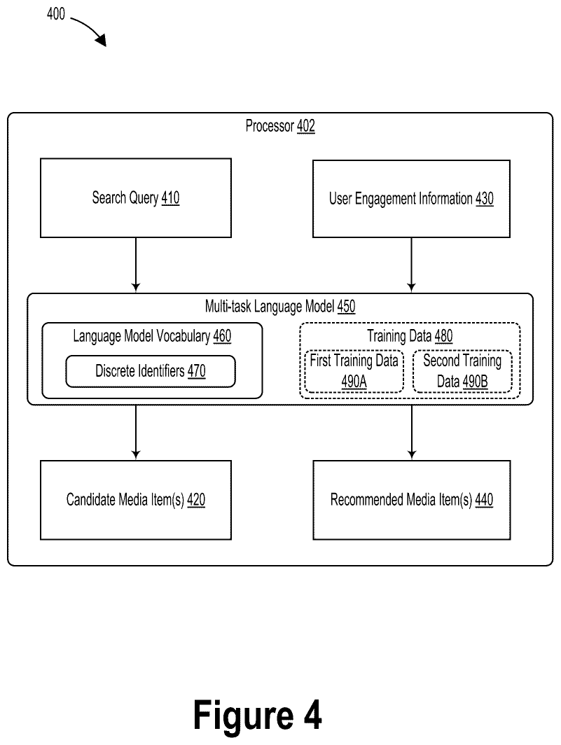

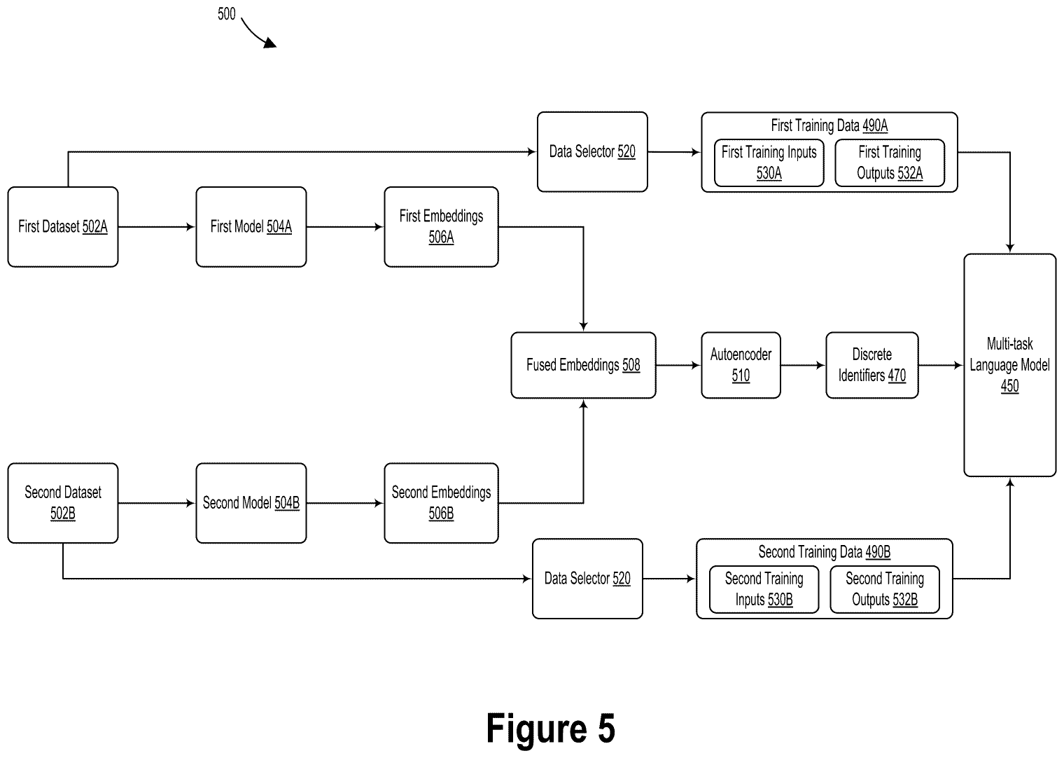

As described in greater detail with respect to FIGS. 4-5, training and/or generation of a single generative retrieval model (Gen_{R+S}) based on (i) the generative model (Gen_{S}) and (ii) the generative model (Gen_{R}) is described. In particular, a multi-task language model 450 (e.g., Gen_{R+S}) is described that outperforms task-specific information retrieval models (e.g., the generative model (Gen_{R}) and/or (ii) the generative model (Gen_{S})) for media content servers.

### II. Example Media Content Delivery System

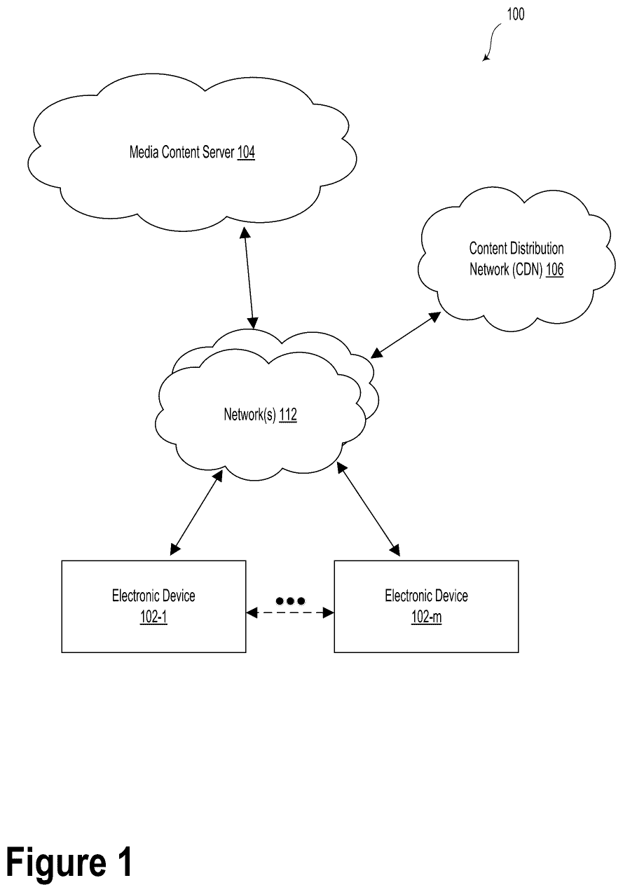

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicatively couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, infotainment system, digital media player, speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items (and possibly the media content items) to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

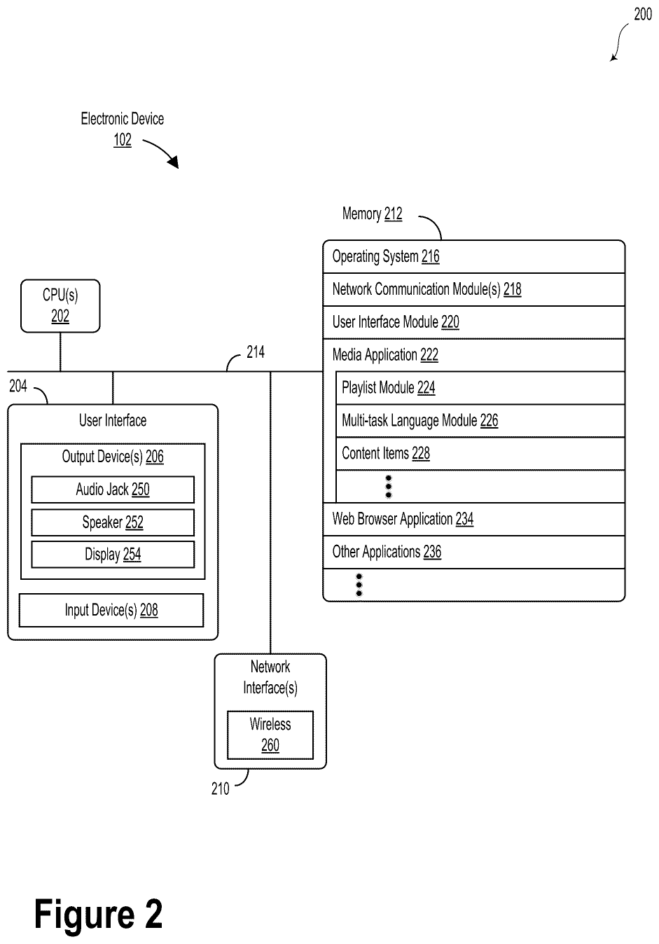

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice application programming interface (API), a connect API, and/or a key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram 200 illustrating an electronic device 102 (e.g., electronic device 102-1 and/or electronic device 102-m, FIG. 1) in accordance with some embodiments. The electronic device 102 includes one or more central processing units (CPU(s) 202, i.e., processors or cores), one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. The electronic device 102 could include a display 254. The display 254 could be, for example, configured to present visual information and interact with user inputs. The display 254 could include a multi-layered structure designed for integration into electronic devices, comprising a primary visual output layer. In some examples, the visual output layer may be constructed from an active matrix OLED (AMOLED) panel, which offers high-resolution color output and wide viewing angles. Beneath the visual output layer, a touch-sensitive layer could be provided enabling precise detection of user input through direct contact or proximity sensing. The display 254 further incorporates a cover layer made of chemically strengthened glass or flexible polymer, providing durability and protection against impact and scratches.

Furthermore, some electronic devices 102 use a microphone and voice recognition device to supplement or replace the keyboard. Optionally, the electronic device 102 includes an audio input device (e.g., a microphone) to capture audio (e.g., speech from a user).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are conducted using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are conducted using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof: an operating system 216, network communication module(s) 218, a user interface module 220, a media application 222, a web browser application 234, and other applications 236.

The operating system 216 may include procedures for handling various basic system services and for performing hardware-dependent tasks. Network communication module(s) 218 may connect the electronic device 102 to other computing devices (e.g., media presentation system(s), media content server 104, and/or other client devices) via the one or more network interface(s) 210 (wired or wireless) connected to one or more network(s) 112. The user interface module 220 may receive commands and/or inputs from a user via the user interface 204 (e.g., from the input devices 208) and provides outputs for playback and/or display on the user interface 204 (e.g., the output devices 206). Media application 222 (e.g., an application for accessing a media-providing service of a media content provider associated with media content server 104) may provide uploading, browsing, receiving, processing, presenting, and/or requesting playback of media (e.g., media items).

In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof: a playlist module 224, a multi-task language module 226, and a content items module 228.

The playlist module 224 may store sets of media items for playback in a predefined order. In some embodiments, the playlist module 224 is configured to generate playlists. In some embodiments, the playlist module 224 includes a diffusion model component, a large language model component, and/or a nearest neighbor search component. The multi-task language module 226 may identify and/or display recommended media items (e.g., to include in a playlist). In some embodiments, the multi-task language module 226 includes a diffusion model component, a large language model component, and/or a nearest neighbor search component. The content items module 228 may store media items, including audio items such as podcasts and songs, for playback and/or for forwarding requests for media content items to the media content server. In some embodiments, the content item module 228 includes a set of vector representations for the media items.

The web browser application 234 may access, view, and interact with web sites. In doing so, the web browser application 234 may using web-based communication protocols, web-based applications, and/or web-based content formats.

The other applications 236 may include applications for word processing, calendaring, mapping, weather, time keeping, virtual digital assistant, presenting, drawing, instant messaging, e-mail, telephony, video conferencing, photo management, video management, a digital music player, a digital video player, 2D gaming, 3D (e.g., virtual reality) gaming, electronic book reader, and/or workout support.

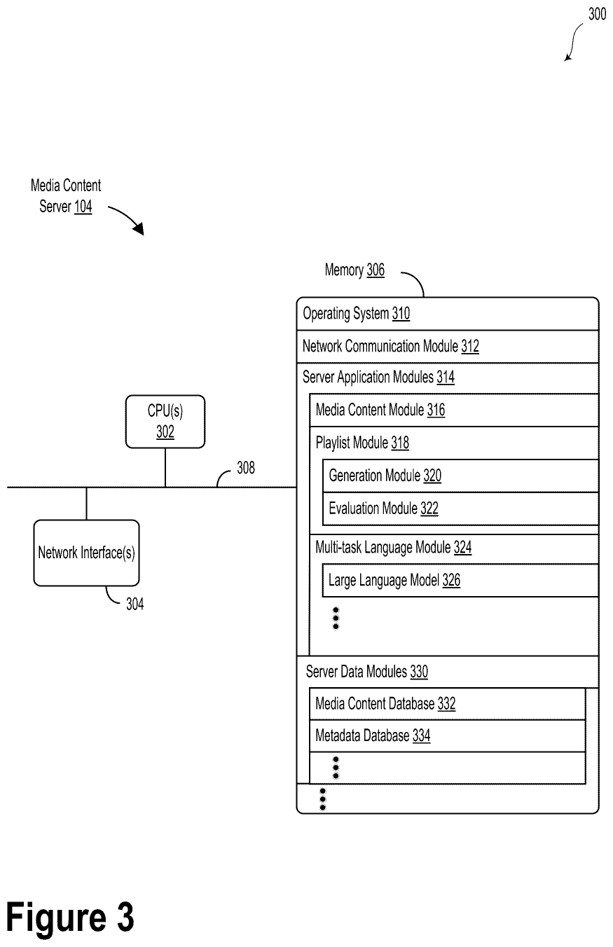

FIG. 3 is a block diagram illustrating a media content server 104 in accordance with some embodiments. The media content server 104 typically includes one or more CPUs 302, one or more network interfaces 304, memory 306, and one or more communication buses 308 for interconnecting these components.

Memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof: an operating system 310, a network communication module 312, one or more server application modules 314, and one or more server data module(s) 330.

The operating system 310 may include procedures for handling various basic system services and for performing hardware-dependent tasks.

The network communication module 312 may be used for connecting the media content server 104 to other computing devices via one or more network interfaces 304 (wired or wireless) connected to one or more networks 112.

The one or more server application modules 314 may perform various functions with respect to providing and managing a content service, the server application modules 314 including, but not limited to, one or more of: a media content module 316, a playlist module 318, and a multi-task language module 324.

The media content module 316 may store one or more media content items and/or send (e.g., stream), to the electronic devices, one or more requested media content item(s).

The playlist module 318 may be for storing and/or providing (e.g., streaming) sets of media content items (e.g., to the electronic devices 102). In some embodiments, the playlist module 318 includes one or more of: a generation module 320 for generating playlists and media sets and an evaluation module 322 for evaluating the playlists and media sets, e.g., before and after publication. In some embodiments, the playlist module 318 includes a diffusion model component, a large language model component, and/or a nearest neighbor search component.

The multi-task language module 324 may determine and/or provide media item recommendations (e.g., for a playlist). In some embodiments, the multi-task language module 324 includes a diffusion model component, a large language model 326 component, and/or a nearest neighbor search component. In various examples, large language model 326 could include a local language model and/or a remote language model.

Some large language models 326 could be hosted locally, such as on a user's own computing device or a local server. Such models may offer improved privacy and security since user data does not need to be sent externally. These models utilize local hardware resources and are directly accessible within the local network.

Remote language models can be hosted on cloud servers managed by an external provider, making them accessible via the internet. This setup benefits from the cloud's scalability and reliability, with performance not limited by local hardware. These models can be maintained by the provider (e.g., the media content server 104).

The one or more server data module(s) 330 may manage the storage of and/or access to media items and/or metadata relating to the media items. In some embodiments, the one or more server data module(s) 330 include: a media content database 332 for storing media items and/or vector representations (or other embeddings) for the media items; and a metadata database 334 for storing metadata relating to the media items, such as a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system manages during peak usage periods as well as during average usage periods.

### III. Digital Audio Content and Streaming

Digital audio content, as discussed herein, encompasses abroad range of audio data that has been converted into a digital format, enabling it to be stored, processed, transmitted, and received by electronic devices. This can include spoken word recordings, such as news broadcasts, podcasts, audiobooks, and lectures, which offer listeners a convenient way to consume information and entertainment through auditory means. Additionally, digital audio content can combine spoken word with music or other sounds, creating rich, multi-layered audio experiences commonly found in radio shows, multimedia presentations, and enhanced podcasts. Furthermore, digital audio content often constitutes the audio portion of digital video content, such as the soundtrack of movies, television shows, online videos, and live streams. This integration allows for synchronized audio-visual experiences that enhance the storytelling and engagement of visual media. Digital audio content is typically compressed using various encoding techniques (e.g., MP3, AAC, or Opus) to reduce file size while maintaining quality, and it can be distributed across a multitude of platforms, including streaming services, downloadable files, and broadcasting networks. Digital audio content may also be obtained from audio/video encodings, such as H.264/MPEG-4 or 3GP.

For instance, digital audio content streaming involves transmitting audio data from a media content server 104 to electronic devices 102 over a network 112. At the media content server 104, the process may involve content preparation, where the audio is encoded using compression algorithms (if it is not already compressed). The encoded audio is then segmented into smaller pieces, making it easier to stream continuously. These audio content pieces, along with associated metadata, are stored on the media content server 104. To facilitate delivery, the server may utilize the CDN 106, which caches the audio content pieces on geographically distributed servers, reducing latency and improving reliability. The media content server 104 may employ streaming protocols such as HTTP Live Streaming (HLS), Dynamic Adaptive Streaming over HTTP (DASH), or the Real-Time Messaging Protocol (RTMP) to transmit the audio segments. These protocols manage the data transmission and adapt to varying network conditions. Additionally, the media content server 104 handles user sessions, managing requests for specific audio streams and providing secure access through authentication and authorization mechanisms.

On the receiving end, electronic devices 102 may initiate a connection to the media content server 104 by requesting a specific audio stream. After receiving the initial audio segments, the electronic device 102 begins buffering, pre-loading a portion of the audio into memory to provide smooth playback even in the case of minor network interruptions. The buffered pieces are then decoded from their compressed format back into an audio signal by media player software of the electronic device 102. Adaptive streaming protocols, such as those discussed above, allow the electronic device 102 to monitor network conditions and request different quality levels of digital audio content based on current bandwidth availability, thus providing consistent playback without interruptions in most cases. The electronic device 102 also handles network errors and interruptions by attempting to reconnect to the media content server 104, re-buffering when necessary, and dynamically adjusting the stream quality to maintain a continuous audio experience. The decoded audio may be played through the electronic device 102 (e.g., via speakers or headphones), with the media player software managing playback controls like play, pause, skip, and volume adjustment.

### IV. Example Natural Language Models

As discussed above, the embodiments herein may employ natural language models. Language models (LMs) are one example of such a natural language model. These LMs may operate as networked servers that take in information from a client device as a prompt and provide a semantically appropriate response as output to the client device.

In general, an LM is an advanced computational model, primarily functioning within the domain of natural language processing and machine learning. An LM can be configured to understand, interpret, generate, and respond to human language in a manner that is both contextually relevant and syntactically coherent. The underlying structure of an LM is typically based on a neural network architecture, more specifically, a variant of the transformer model. Transformers are notable for their ability to process sequential data, such as text, with high efficiency.

The operation of an LM involves layers of interconnected processing units, known as neurons, which collectively form a deep neural network. This network can be trained on vast datasets comprising text from diverse sources, thereby enabling the LM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LM's output and expected output.

An aspect of an LM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LMs highly versatile and applicable in various domains, including but not limited to, chatbot development, content creation, language translation, and sentiment analysis.

Some LMs are multimodal in that they can receive prompts in formats other than text and can produce outputs in formats other than text. Thus, while LMs are predominantly designed for understanding and generating textual data, multimodal LMs extend this functionality to include multiple data modalities, such as visual and auditory inputs, in addition to text.

A multimodal LM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LM involves multimodal datasets, enabling the model to learn not only language patterns but also the correlations and interactions between different types of data. This cross-modal training results in multimodal LMs being adept at tasks that require an understanding of complex relationships across multiple data forms, a capability that text-only LMs do not possess. This makes multimodal LMs particularly suited for advanced applications that necessitate a holistic understanding of multimodal information, such as chatbots that can interpret and produce images and/or audio.

### V. Example Systems

Referring to FIG. 4, an example system 400 that provides improved digital content recommendations and search results by using a multi-task language model is shown, in accordance with example embodiments. The example system 400 orchestrates and generates search results and recommendations based on users' entertainment needs. The example system 400 advances the user content search and recommendation process from a conventional media content delivery system to an agent that gauges an individual user's intent to provide more relevant recommendations and search results.

To illustrate, the system 400 includes a multi-task language model 450. According to some embodiments, the multi-task language model 450 may correspond to the multi-task language module 226 of FIG. 2. In these embodiments, the multi-task language model 450 may be integrated into the electronic device 102. According to other embodiments, the multi-task language model 450 may correspond to the multi-task language module 324 of FIG. 3. In these embodiments, the multi-task language model 450 may be integrated into the media content server 104.

As depicted in FIG. 4, the multi-task language model 450 may be hosted by a processor 402. In some embodiments, the processor 402 may correspond to the CPU(s) 202 of FIG. 2. For example, the multi-task language model 450 may be hosted by a processor on a client device (e.g., the electronic device 102). In other embodiments, the processor 402 may correspond to the CPU(s) 302 of FIG. 3. For example, the multi-task language model 450 may be hosted by a server (e.g., the media content server 104).

In some examples, the processor 402 may be configured to provide a search query 410 to the multi-task language model 450. The search query 410 may be provided to the multi-task language model 450 as a prompt or another textual representation of a search intent. As a non-limiting example, the search query 410 may be a natural language prompt that includes information, provided by a user, for a search related to a media content delivery system. To illustrate, using a user interface of the electronic device 102, the user may provide a string of text to a media platform associated with the media content server 104. The string of text (e.g., the search query 410) may be transmitted to the media content server 104 as a prompt.

The processor 402 may be configured to identify and retrieve, using the multi-task language model 450 and based on the search query 410, one or more candidate media items 420 from a media item database (e.g., the media content database 332) of the media content delivery system (e.g., the media content server 104). For example, as described in greater detail below, the multi-task language model 450 may be a generative model that is trained based on content-based information (e.g., tokens for textual queries). Based on the training, the multi-task language model 450 may identify and retrieve candidate media items 420 that are relevant to the search query 410.

Additionally, the multi-task language model 450 may be trained to provide recommendations to a user based on user engagement. For example, the processor 402 may be configured to provide user engagement information 430 to the multi-task language model 450. The user engagement information 430 may indicate user engagement activity with the media content delivery system. User engagement activity may be based on a variety of different parameters. Non-limiting examples of user engagement activity may include indications of media items that a user has previously accessed (e.g., selected), indications of media items that a user has previewed for at least a particular time period, indications of media items that a user has “liked”, indications of media items that a user has “disliked”, indications of media items that a user has shared, indications of media items to which a user has left a comment, etc.

The user engagement information 430 may be provided to the multi-task language model 450 as a prompt. In some embodiments, the user engagement information 430 may be collected and stored at a user device (e.g., the electronic device 102) and periodically transmitted to the multi-task language model 450 as a prompt. In other embodiments, the user engagement information 430 may be dynamically transmitted to the multi-task language model 450 as the user navigates through the media platform such that the user engagement information 430 provided to the multi-task language model 450 is continuously updated.

The processor 402 may be configured to identify, using the multi-task language model 450 and based on the user engagement information, one or more recommended media items 440 from the media item database (e.g., the media content database 332). For example, based on the training, the multi-task language model 450 may identify recommended media items 440 that are determined to have a high likelihood of user interest based on previous user engagement activity.

Thus, the multi-task language model 450 may be able to (i) identify the candidate media items 420 based on search query 410 and (ii) recommend media items 440 based on the user engagement information 430 as a result of the training process. The training data 480 used to train the multi-task language model 450 may include first training data 490A for search queries associated with media items and second training data 490B for user-based recommendations associated with media items. The first training data 490A may aid the multi-task language model 450 with identifying the candidate media items 420 based on the search query 410, and the second training data 490B may aid the multi-task language model 450 with recommending the media items 440 based on the user engagement information 430.

The first training data 490A may include training inputs and corresponding training outputs. In some embodiments, the training inputs of the first training data 490A may include tokens for textual queries, and the training outputs of the first training data 490A may include tokens for media items relevant to corresponding textual queries.

The second training data 490B may include training inputs and corresponding training outputs. In some embodiments, the training inputs of the second training data 490A may include tokens for previously accessed media items, and the training outputs of the second training data 490B may include tokens for media items relevant to previously accessed media items.

Additionally, a language model vocabulary 460 of the multi-task language model 450 may include discrete identifiers 470 generated during the training process. The language model vocabulary 460 may be composed of (i) vocabulary tokens that represent textual natural language and (ii) the tokens used to represent media items in the media content database 332. The discrete identifiers 470 may be used as a mechanism to select different media items, such as the candidate media items 420 or the recommended media items 440, based on underlying embeddings. As described in greater detail with respect to FIG. 5, the discrete identifiers 470 may be generated by encoding embeddings associated with the first training data 490A and the second training data 490B.

By training the multi-task language model 450 based on content-based information (e.g., tokens for textual queries) and collaborative-filtering-based information (e.g., tokens for historical media items), recommendations generated by the multi-task language model 450 may be less biased toward popularity and more biased towards user preference.

Referring to FIG. 5, an example system 500 for training a multi-task language model is shown, in accordance with example embodiments. For example, the system 500 may be used to train the multi-task language model 450 of FIG. 4.

According to the system 500, a first dataset 502A is provided to a first model 504A. The first dataset 502A may include training data for search queries associated with media items. For example, the first dataset 502A may include (i) input training data indicating examples of textual search queries for media items and (ii) corresponding output training data indicating relevant media items to the textual search queries.

The first model 504A may be configured to generate first embeddings 506A based on the first dataset 502A. In one embodiment, the first model 504A may include a bi-encoder. The first dataset 502A may be used to train the first model 504A as a search-based model, and the first model 504A may output the first embeddings 506A based on the first dataset 502A.

According to the system 500, a second dataset 502B is provided to a second model 504B. The second dataset 502B may include training data for user-based recommendations associated with media items. For example, the second dataset 502B may include (i) input training data indicating examples of user interactions with media items and (ii) corresponding output training data indicating relevant media items to the user interactions.

The second model 504B may be configured to generate second embeddings 506B based on the second dataset 502B. In one embodiment, the second model 504B may include a two-tower model. The second dataset 502B may be used to train the second model 504B as a recommendation model, and the second model 504B may output the second embeddings 506B based on the second dataset 502B.

According to the system 500, the first embeddings 506A and the second embeddings 506B may be combined (e.g., fused together) to generate fused embeddings 508 that are provided to an autoencoder 510. In one embodiment, the autoencoder 510 may be a Residual-Quantized Variational Autoencoder (RQ-VAE). The autoencoder 510 may be configured to encode the fused embeddings 508 to generate the discrete identifiers 470 that are added to the language model vocabulary 460 of the multi-task language model 450, as described with respect to FIG. 4.

To train the multi-task language model 450, a subset of the first dataset 502A and a subset of the second dataset 502B are provided to the multi-task language model 450 as training data. Selecting subsets of datasets 502A, 502B enables the system 500 to avoid redundancy with regards to training data. To illustrate, the first dataset 502A and the second dataset 502B may be provided to a data selector 520. The data selector 520 may be configured to select (i) a subset of the first dataset 502A as the first training data 490A and (ii) a subset of the second dataset 502B as the second training data 490B. In some embodiments, the first training data 490A (e.g., the data in the subset of the first dataset 502A) is distinct from the second training data 490B (e.g., the data in the subset of the second dataset 502B).

The first training data 490A includes first training inputs 530A and corresponding first training outputs 532A. In some embodiments, the first training inputs 530A include tokens for textual queries, and the first training outputs 532A include tokens for media items relevant to the corresponding textual queries. The second training data 490B includes second training inputs 530B and corresponding second training outputs 532B. In some embodiments, the second training inputs 530B include tokens for previously accessed media items, and the second training outputs 532B include tokens for media items relevant to the previously accessed media items.

The data selector 520 may be configured to provide the first training inputs 530A and the first training outputs 532A to the multi-task language model 450. Additionally, the data selector 520 may be configured to provide the second training inputs 530B and the second training outputs 532B to the multi-task language model 450. The multi-task language model 450 may be trained based on the first and second training data 490A, 490B to enable the multi-task language model 450 to (i) identify the candidate media items 420 based on search query 410 and (ii) recommend the media items 440 based on user engagement information 430.

The multi-task language model 450 utilizes generative retrieval to (i) search for candidate media items 420 and (ii) recommend media items 440, offering an alternative to traditional methods that depend on external indexes and nearest-neighbor searches. Instead, the multi-task language model 450 associates the inputs (e.g., the search query 410 and/or the user engagement information 430) with item identifiers, such as the discrete identifiers 470. In some embodiments, the multi-task language model 450 may be a large language model (LLM) that can centralize a variety of informational retrieval tasks, such as query understanding, retrieval, recommendation, explanation, re-ranking, and response generation.

The multi-task language model 450 may outperform task-specific information retrieval models (e.g., search-specific models and/or recommendation-specific models) for media content servers. For example, latent representations of media items learned by generative recommenders (e.g., recommendation-specific models) may be biased towards popularity. Because content-based and collaborative-filtering-based information can improve representations of a media item, the joint training (e.g., training based on the first and second datasets 502A, 502B) may regularize (i) the estimation of each media item's popularity and (ii) the media item's latent representations. For example, the search capability of the multi-task language model 450 captures content-based aspects of a media item and the recommendation capability of the multi-task language model 450 captures collaborative-filtering aspects.

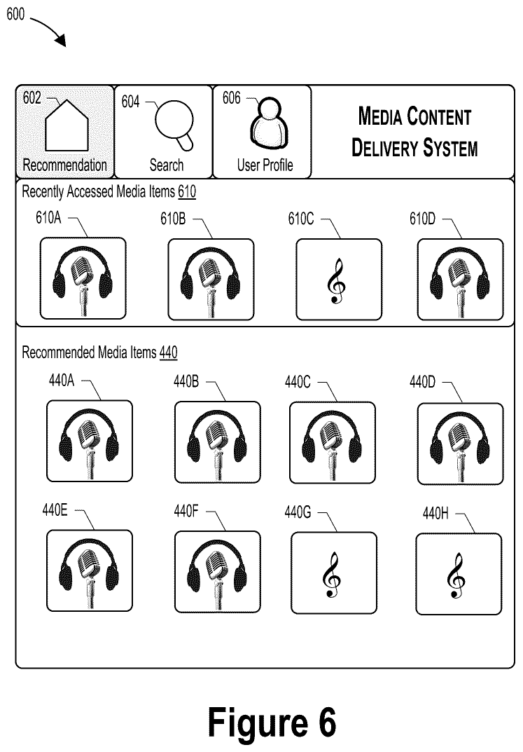

Referring to FIG. 6, a first page of an example graphical user interface 600 is shown, in accordance with example embodiments. The graphical user interface 600 may be integrated into a client device, such as the electronic device 102 of FIG. 1. In FIG. 6, the graphical user interface 600 may be associated with a media content delivery system. More specifically, in some embodiments, the media content delivery system may be a streaming media content delivery system and the graphical user interface 600 may provide a mechanism that enables a user of the electronic device 102 to interact with the streaming media content delivery system.

In FIG. 6, the graphical user interface 600 includes a plurality of different pages. For example, the graphical user interface 600 includes recommendation page 602, a search page 604, and a user profile page 606. The pages depicted in FIG. 6 are merely illustrative and are not intended to be limiting. In other embodiments, the graphical user interface 600 can include additional pages, such as subscription page, a favorite page, etc.

In FIG. 6, the recommendation page 602 is selected. In some embodiments, the recommendation page 602 may present (e.g., display) recently accessed media items 610. To illustrate, the recommendation page 602 present a media item 610A (e.g., a podcast) as recently accessed by the user, a media item 610B (e.g., another podcast) as recently accessed by the user, a media item 610C (e.g., a song) as recently accessed by the user, and a media item 610D (e.g., another podcast) as recently accessed by the user.

The recommendation page 602 may also present the one or more recommended media items 440. For example, after the multi-task language model 450 recommends media items 440 based on the user engagement information 430 (e.g., the recently accessed media items 610), the recommended media items 440 may be presented via the graphical user interface 600 in response to detecting a particular page (e.g., the recommendation page 602) of the media content delivery system has been accessed.

In FIG. 6, the recommended media items 440 may include a media item 440A (e.g., a podcast), a media item 440B (e.g., another podcast), a media item 440C (e.g., another podcast), a media item 440D (e.g., another podcast), a media item 440E (e.g., another podcast), a media item 440F (e.g., another podcast), a media item 440G (e.g., a song), and a media item 440H (e.g., another song). One or more of the media items 440A-440F (e.g., one or more of the podcasts) may have similarities (e.g., similar topics of discussion, similar hosts, similar genres, etc.) as one or more of the recently accessed media items 610A, 610B, 610C. In some embodiments, the multi-task language model 450 may recommend one or more of the media items 440A-440F (e.g., one or more of the podcasts) because the podcast have similarities to the media item 610C (e.g., the song). As a non-limiting example, the podcast topic in one or more of the media items 440A-440F may reference the song indicated by the recently accessed media item 610C. Likewise, one or more of the media items 440G, 440H (e.g., one or more of the songs) may have similarities (e.g., similar genres, similar artists, etc.) as the recently accessed media item 610C.

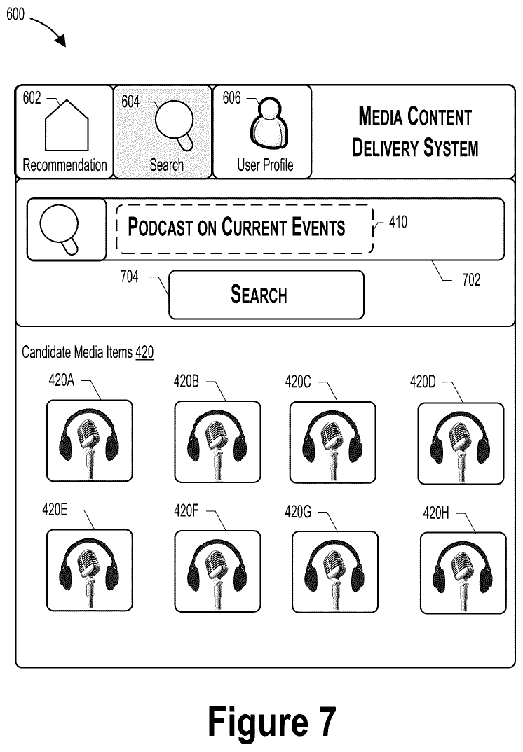

Referring to FIG. 7, a second page of the example graphical user interface 600 is shown, in accordance with example embodiments.

In FIG. 7, the search page 604 is selected. The search page 604 may include a search prompt 702 that enables the user to insert, via voice or text, the search query 410. In the illustrative example of FIG. 7, the search query 410 is a text string that states “Podcast on Current Events”. It should be understood that the search query 410 depicted in FIG. 7 is merely for illustrative purposes and should not be construed as limiting. In other embodiments and examples, different search queries may be provided to the search prompt 702. After the search query 410 is provided in the search prompt 702, the user may press a search option 704 such that the search query 410 is provided to the multi-task language model 450 as a prompt. Thus, the search query 410 may be received via the graphical user interface 600.

The search page 604 may also present the one or more candidate media items 420. For example, after the multi-task language model 450 identifies the candidate media items 420 based on the search query 410, the candidate media items 420 may be presented via the graphical user interface 600 in response. In FIG. 6, the candidate media items 420 may include a media item 420A (e.g., a podcast), a media item 420B (e.g., another podcast), a media item 420C (e.g., another podcast), a media item 420D (e.g., another podcast), a media item 420E (e.g., another podcast), a media item 420F (e.g., another podcast), a media item 420G (e.g., another podcast), and a media item 420H (e.g., another podcast). Each candidate media item 420A-420H may be relevant to the search query 410.

### VI. Example Operations

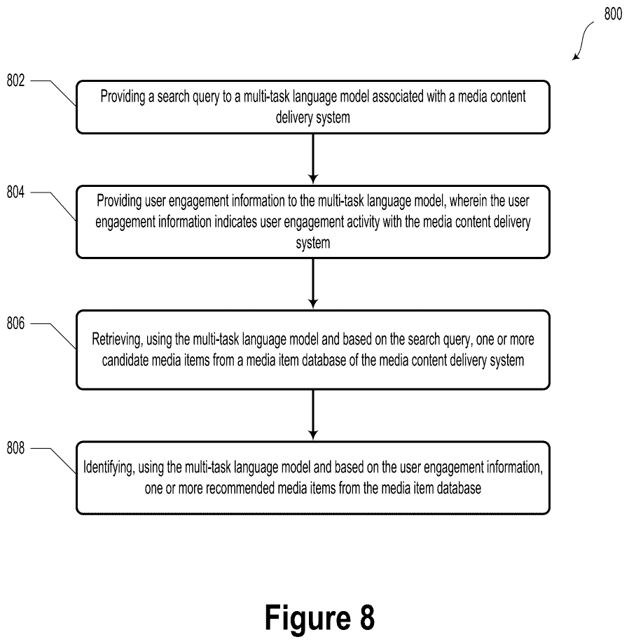

FIG. 8 is a flow chart illustrating an example embodiment. The method 800 illustrated by FIG. 8 may be carried out by a computing device, such as media content server 104, and/or one or more additional computing devices arranged to prepare digital audio content. Alternatively, the process can be carried out by other types of devices or device subsystems.

The embodiments of FIG. 8 may be simplified by the removal of any one or more of the features or blocks shown therein. Further, these embodiments may be combined with features, blocks, aspects, and/or implementations of any of the previous figures or otherwise described herein.

The method 800 includes providing a search query to a multi-task language model associated with a media content delivery system, at block 802. For example, referring to FIG. 4, the processor 402 may provide the search query to the multi-task language model 450 associated with the media content server 104.

The method 800 includes providing user engagement information to the multi-task language model, at block 804. The user engagement information indicates user engagement activity with the media content delivery system. For example, referring to FIG. 4, the processor provides the user engagement information 430 to the multi-task language model 450. The user engagement information 430 indicates user engagement activity with the media content server 104.

The method 800 includes retrieving, using the multi-task language model and based on the search query, one or more candidate media items from a media item database of the media content delivery system, at block 806. For example, referring to FIG. 4, the processor 402 may identify and retrieve, using the multi-task language model 450 and based on the search query 410, the candidate media items 420 from the media content database 332 of the media content server 104.

The method 800 includes identifying, using the multi-task language model and based on the user engagement information, one or more recommended media items from the media item database, at block 808. For example, referring to FIG. 4, the processor 402 may identify and retrieve, using the multi-task language model 450 and based on the user engagement information 430, the recommended media items 440 from the media content database 332.

According to one implementation, the method 800 may include training the multi-task language model 450 prior to providing the search query 410 and the user engagement information 430 to the multi-task language model 450. Training the multi-task language model 450 may include generating first embeddings 506A based on a first dataset 502A. The first dataset 502A may include training data for search queries associated with media items. Training the multi-task language model 450 may also include generating second embeddings 506B based on a second dataset 502B. The second dataset 502B may include training data for user-based recommendations associated with media items. Training the multi-task language model 450 may also include generating fused embeddings 508 by combining the first embeddings 506A and the second embeddings 506B. Training the multi-task language model 450 may also include encoding the fused embeddings 508 to generate discrete identifiers 470 that are added to a vocabulary 460 of the multi-task language model 450.

According to one implementation of the method 800, the first embeddings 506A are generated by a first model 504A, and the second embeddings 506B are generated by a second model 504B. According to one implementation of the method 800, the first model 504A includes a bi-encoder model. According to one implementation of the method 800, the second model 504B includes a two-tower model.

According to one implementation of the method 800, after the discrete identifiers 470 are added to the vocabulary 460 of the multi-task language model 450, training the multi-task language model 450 further includes providing first training inputs 530A and first training outputs 532A to the multi-task language model 450 based on a subset of the first dataset 502A. Training the multi-task language model 450 may also include providing second training inputs 530B and second training outputs 532B to the multi-task language model 450 based on a subset of the second dataset 502B. According to one implementation of the method 800, the data in the subset of the first dataset 502A (e.g., the first training data 490A) is distinct from the data in the subset of the second dataset 502B (e.g., the second training data 490B).

According to one implementation of the method 800, the first training inputs 530A include tokens for textual queries, and the first training outputs 532A include tokens for media items relevant to corresponding textual queries. According to one implementation of the method 800, the second training inputs 530B include tokens for previously accessed media items, and the second training outputs 532B include tokens for media items relevant to the previously accessed media items.

According to one implementation of the method 800, the multi-task language model 450 is hosted by a server (e.g., the media content server 104). According to one implementation of the method 800, the multi-task language model 450 is hosted by a processor on a client device (e.g., the electronic device 102).

According to one implementation, the method 800 may include presenting the one or more candidate media items 420 via a graphical user interface 600 in response to retrieving the one or more candidate media items 420. According to one implementation, the method 800 may include presenting the one or more recommended media items 440 via a graphical user interface 600 in response to detecting a particular page (e.g., the recommendation page 602) of the media platform has been accessed. According to one implementation, the method 800 may include presenting the one or more recommended media items 440 via a graphical user interface 600 in response to identifying the one or more recommended media items 440.

According to one implementation of the method 800, the search query 410 is received via a graphical user interface 600. According to one implementation, the media content delivery system (e.g., the media content server 104) includes a streaming media content delivery system.

The method 800 utilizes generative retrieval to (i) search for candidate media items 420 and (ii) recommend media items 440, offering an alternative to traditional methods that depend on external indexes and nearest-neighbor searches. Instead, the multi-task language model 450 associates the inputs (e.g., the search query 410 and/or the user engagement information 430) with item identifiers, such as the discrete identifiers 470. In some embodiments, the multi-task language model 450 may be a LLM that can centralize a variety of informational retrieval tasks, such as query understanding, retrieval, recommendation, explanation, re-ranking, and response generation.

The method 800 may result in outperformance of task-specific information retrieval models (e.g., search-specific models and/or recommendation-specific models) for media content servers. For example, latent representations of media items learned by generative recommenders (e.g., recommendation-specific models) may be biased towards popularity. Because content-based and collaborative-filtering-based information can improve representations of a media item, the joint training (e.g., training based on the first and second datasets 502A, 502B) may regularize (i) the estimation of each media item's popularity and (ii) the media item's latent representations. For example, the search capability of the multi-task language model 450 captures content-based aspects of a media item and the recommendation capability of the multi-task language model 450 captures collaborative-filtering aspects.

### VII. Example Non-Transitory Computer-Readable Media

Some or all of the operations described herein may be embodied in a non-transitory computer-readable medium. Such a computer-readable medium has stored thereon program instructions that, upon execution by a computing system, cause the computing system to perform various operations.

The program instructions could be configured for providing a search query to a multi-task language model associated with a media content delivery system.

The program instructions could also be configured for providing user engagement information to the multi-task language model. The user engagement information indicates user engagement activity with the media content delivery system.

The program instructions could also be configured for retrieving, using the multi-task language model and based on the search query, one or more candidate media items from a media item database of the media content delivery system.

The program instructions could also be configured for identifying, using the multi-task language model and based on the user engagement information, one or more recommended media items from the media item database.

In some examples, the program instructions could be configured for training the multi-task language model prior to providing the search query and the user engagement information to the multi-task language model. In such scenarios, training the multi-task language model may include generating first embeddings based on a first dataset. The first dataset comprises training data for search queries associated with media items. Training the multi-task language model may also include generating second embeddings based on a second dataset. The second dataset comprises training data for user-based recommendations associated with media items. Training the multi-task language model may also include generating fused embeddings by combining the first embeddings and the second embeddings. Training the multi-task language model may also include encoding the fused embeddings to generate discrete identifiers that are added to a vocabulary of the multi-task language model.

In some examples, after the discrete identifiers are added to the vocabulary of the multi-task language model, training the multi-task language model may include providing first training inputs and first training outputs to the multi-task language model based on a subset of the first dataset. Training the multi-task language model may also include providing second training inputs and second training outputs to the multi-task language model based on a subset of the second dataset.

The program instructions could yet further be configured for presenting the one or more candidate media items via a graphical user interface in response to retrieving the one or more candidate media items.

The program instructions could further be configured for presenting the one or more recommended media items via a graphical user interface in response to detecting a particular page of the media platform has been accessed.

### VIII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
providing a search query to a multi-task language model associated with a media content delivery system;
providing user engagement information to the multi-task language model, wherein the user engagement information indicates user engagement activity with the media content delivery system;
retrieving, using the multi-task language model and based on the search query, one or more candidate media items from a media item database of the media content delivery system; and
identifying, using the multi-task language model and based on the user engagement information, one or more recommended media items from the media item database.

2. The computer-implemented method of claim 1, further comprising training the multi-task language model prior to providing the search query and the user engagement information to the multi-task language model, wherein training the multi-task language model comprises:
generating first embeddings based on a first dataset, wherein the first dataset comprises training data for search queries associated with media items;
generating second embeddings based on a second dataset, wherein the second dataset comprises training data for user-based recommendations associated with media items;
generating fused embeddings by combining the first embeddings and the second embeddings; and
encoding the fused embeddings to generate discrete identifiers that are added to a vocabulary of the multi-task language model.

3. The computer-implemented method of claim 2, wherein the first embeddings are generated by a first model, and wherein the second embeddings are generated by a second model.

4. The computer-implemented method of claim 3, wherein the first model comprises a bi-encoder model.

5. The computer-implemented method of claim 3, wherein the second model comprises a two-tower model.

6. The computer-implemented method of claim 2, wherein, after the discrete identifiers are added to the vocabulary of the multi-task language model, training the multi-task language model further comprises:
providing first training inputs and first training outputs to the multi-task language model based on a subset of the first dataset; and
providing second training inputs and second training outputs to the multi-task language model based on a subset of the second dataset.

7. The computer-implemented method of claim 6, wherein the first training inputs comprise tokens for textual queries, and wherein the first training outputs comprise tokens for media items relevant to corresponding textual queries.

8. The computer-implemented method of claim 6, wherein the second training inputs comprise tokens for previously accessed media items, and wherein the second training outputs comprise tokens for media items relevant to the previously accessed media items.

9. The computer-implemented method of claim 6, wherein data in the subset of the first dataset is distinct from data in the subset of the second dataset.

10. The computer-implemented method of claim 1, wherein the multi-task language model is hosted by a server.

11. The computer-implemented method of claim 1, wherein the multi-task language model is hosted by a processor on a client device.

12. The computer-implemented method of claim 1, further comprising presenting the one or more candidate media items via a graphical user interface in response to retrieving the one or more candidate media items.

13. The computer-implemented method of claim 1, further comprising presenting the one or more recommended media items via a graphical user interface in response to detecting a particular page of an application associated with the media content delivery system has been accessed.

14. The computer-implemented method of claim 1, further comprising presenting the one or more recommended media items via a graphical user interface in response to identifying the one or more recommended media items.

15. The computer-implemented method of claim 1, wherein the search query is received via a graphical user interface.

16. The computer-implemented method of claim 1, wherein the media content delivery system comprises a streaming media content delivery system.

17. A device comprising:
a memory; and
a processor coupled to the memory, the processor configured to:
provide a search query to a multi-task language model associated with a media content delivery system;
provide user engagement information to the multi-task language model, wherein the user engagement information indicates user engagement activity with the media content delivery system;
retrieve, using the multi-task language model and based on the search query, one or more candidate media items from a media item database of the media content delivery system; and
identify, using the multi-task language model and based on the user engagement information, one or more recommended media items from the media item database.

18. The device of claim 17, wherein, to train the multi-task language model, the processor is configured to:
generate first embeddings based on a first dataset, wherein the first dataset comprises training data for search queries associated with media items;
generate second embeddings based on a second dataset, wherein the second dataset comprises training data for user-based recommendations associated with media items;
generate fused embeddings by combining the first embeddings and the second embeddings; and
encode the fused embeddings to generate discrete identifiers that are added to a vocabulary of the multi-task language model.

19. The device of claim 18, wherein, after the discrete identifiers are added to the vocabulary of the multi-task language model, to train the multi-task language model, the processor is further configured to:
provide first training inputs and first training outputs to the multi-task language model based on a subset of the first dataset; and
provide second training inputs and second training outputs to the multi-task language model based on a subset of the second dataset.

20. A non-transitory computer-readable medium comprising instructions that, when executed by a processor, cause the processor to perform operations comprising:
providing a search query to a multi-task language model associated with a media content delivery system;
providing user engagement information to the multi-task language model, wherein the user engagement information indicates user engagement activity with the media content delivery system;
retrieving, using the multi-task language model and based on the search query, one or more candidate media items from a media item database of the media content delivery system; and
identifying, using the multi-task language model and based on the user engagement information, one or more recommended media items from the media item database.
